(19) United States
(12) Patent Application Publication
(10) Pub. No.: US 2022/0318752 A1
(43) Pub. Date: Oct. 6, 2022

(54) SYSTEMS AND METHODS FOR REAL-TIME CONTRACT SETTLEMENT

(71) Applicant: Change Healthcare Holdings, LLC, Nashville, TN (US)

(72) Inventors: Emily Bailey, Seattle, WA (US); Deas Richardson, IV, Nashville, TN (US); Liam Ernest, Seattle, WA (US); Michael Peresie, Nashville, TN (US); Arien Malec, Oakland, CA (US); Shiv Gopalkrishnan, Nashville, TN (US); Avinash Burra, Nashville, TN (US)

(21) Appl. No.: 17/218,434

(22) Filed: Mar. 31, 2021

(51) Int. Cl. G06Q 10/10; G06Q 20/38; G06Q 40/08; H04L 9/32

(52) U.S. Cl. CPC G06Q 10/10; G06Q 20/389; G06Q 20/3825; G06Q 20/38215; G06Q 40/08; H04L 9/32; G06Q 2220/00

(57) ABSTRACT

In one embodiment, a real-time claim processing system is provided that quickly settles received claims. At each stage of the claim processing, the real-time processing system may write some or all of the claim to a distributed ledger, which may be later retrieved and used as evidence of the claim processing. In addition, the claim may be verified by a smart contract associated with the claim that may also control the pricing and settlement of the received claim. The use of a smart contract may allow the claim to be verified and settled in real, or near-real time, which is an improvement over current methods for processing claims which are slow and costly. Smart contracts also provide consistency and transparency to claims processing.

### BACKGROUND

In the insurance industry, healthcare providers now submit claims for reimbursement to insurance companies and payer services through a variety of channels to receive approval or denial of the claim for reimbursement and, ultimately, payment. Preparation of paperwork, processing of claims approval, facilitating payment between parties, and transmitting an electronic notice of the payment(s) are time consuming and involve multiple inputs and outputs. A study published in the Journal of the American Medical Association in October 2019 found that roughly $266 billion a year is wasted on healthcare industry administrative expenses. This waste includes time and resources devoted to managing eligibility, billing, payments, and reporting. A substantial portion of this waste is driven by a lack of transparency and overly complex processes surrounding the revenue cycle. Such processes would benefit from a system and method to reduce unnecessary costs and time associated with the processes.

### SUMMARY

In one embodiment, a real-time claim processing system is provided that quickly settles received claims including validating the claims, pricing the claims, and settling the priced claims by facilitating payment between claim submitters and one or more third-party payers. At each stage of the claim processing, the real-time processing system may write some or all of the claim to a distributed ledger, which may be later retrieved and used as evidence of the claim processing. In addition, the claim may be verified by a smart contract associated with the claim that may also control the pricing and settlement of the received claim. The use of one or many smart contracts may allow the claim to be verified and settled in real, or near-real time, which is an improvement over current methods for processing claims which are slow and costly. Additional benefits of smart contracts over traditional claims processing include improved predictability and transparency.

In an embodiment, a method is provided. The method includes: receiving a claim by a computing device, wherein the claim is associated with a claim identifier; recording the received claim to a distributed ledger by the computing device; determining a smart contract associated with the claim by the computing device; validating the received claim using the determined smart contract by the computing device; recording the validated received claim to the distributed ledger by the computing device; and providing a first transaction identifier associated with the recorded validated received claim on the distributed ledger by the computing device.

Embodiments may include some or all of the following features. Validating the received claim using the determined smart contract by the computing device may include invoking one or more bots identified by the smart contract and validating the received claim using the one or more bots. The smart contract may include a computer program. Recording the validated claim to the distributed ledger may include recording the first transaction identifier associated with the validated claim, the claim identifier, a signature associated with the smart contract, and a time when the claim was validated to the distributed ledger. The distributed ledger may be a blockchain distributed ledger. The method may further include: determining a price for the validated claim using the smart contract; recording the priced claim to the the distributed ledger; and providing a second transaction identifier associated with the recorded priced claim on the distributed ledger. Recording the priced claim to the distributed ledger may include recording the second transaction identifier, the claim identifier, a signature associated with the smart contract, the first transaction identifier, and a time when the claim was priced to the distributed ledger. The method may further include: settling the priced claim using the smart contract; recording the settled claim to the distributed ledger; and providing a third transaction identifier associated with the recorded settled claim on the distributed ledger. Recording the settled claim to the distributed ledger may include recording the third transaction identifier, the claim identifier, a signature associated with the smart contract, the first transaction identifier, the second transaction identifier, and a time when the claim was settled to the distributed ledger.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate a real-time contract settlement system and method. Together with the description, the figures further serve to explain the principles of the real-time contract settlement system and method described herein and thereby enable a person skilled in the pertinent art to make and use the real-time contract settlement system and method.

FIG. 1 is an illustration of an environment for the real-time settlement of claims;

FIG. 2 is an illustration of an example method for the validation of a claim;

FIG. 3 is an illustration of an example method for settling a validated claim;

FIG. 4 is an illustration of an example method for providing a settled claim in response to a request; and

FIG. 5 shows an exemplary computing environment in which example embodiments and aspects may be implemented.

### DETAILED DESCRIPTION

Reference will now be made in detail to embodiments of the document attachment system and method with reference to the accompanying figures. The same reference numbers in different drawings may identify the same or similar elements.

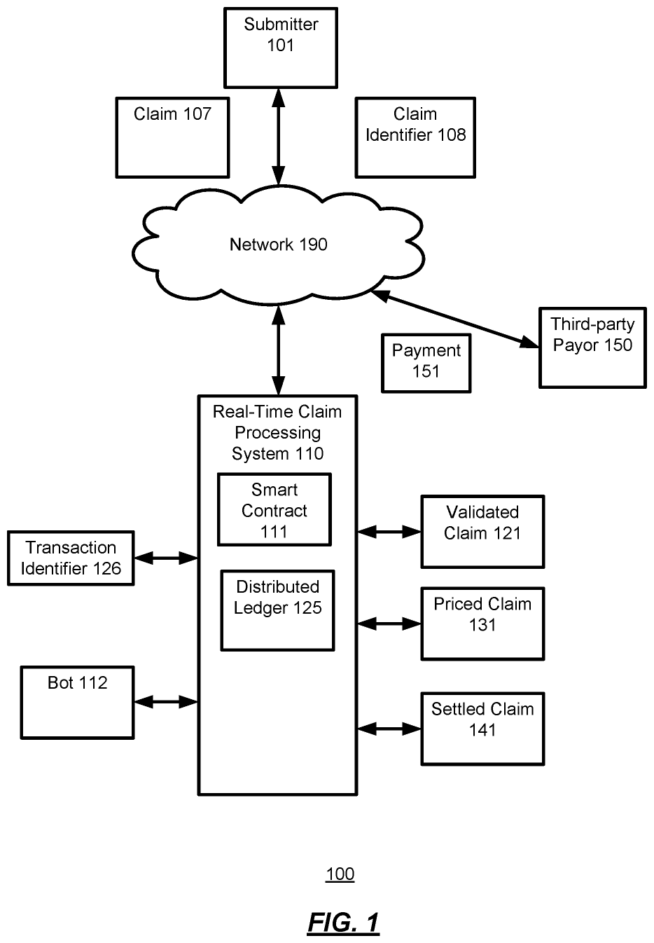

FIG. 1 is an example environment 100 for the real-time settlement of claims 107. As shown, the environment 100 includes a submitter 101, a third-party payor 150, and a real-time processing system 110 communicating through a network 190 (e.g., the internet). While only one submitter 101 and third-party payor 150 are shown, it is for illustrative purposes only; it is contemplated that there may be multiple submitters 101 and third-party payors 150.

The submitter 101 may include medical providers, individuals, or any other entity that may submit a claim 107 or a request to a third-party payor 150. The third-party payor 150 may be a third-party payor in the business of receiving claims 107 from submitters 101 and either paying or denying the claims 107. Examples of third-party payors 150 include insurance companies (e.g., medical insurance payors), and government agencies (e.g., unemployment providers, or Medicaid payors).

Generally, when a claim 107 is submitted by submitter 101 to a third-party payor 150, it may first be processed. Processing may include validating the claim 107 (e.g., determining that the claim is a correct and payable claim based on the terms set forth by the associated payor 150), pricing the claim 107 (e.g., determining how much the third-party payor 150 should pay and what percentage of the claim should be paid by the individual associated with the claim 107), and settling the claim 107 (facilitating the transfer of a payment 151 from the third-party payor 150 to the submitter 101 and/or the individual associated with the claim 107). A claim 107 may be settled by a third-party payor 150 or may be settled on behalf of the third-party payor 150 by another entity.

As described above settling claims 107 (either by the third-party payor 150 or another entity) can be a time-consuming task resulting in delays and unnecessary costs. Many aspects of the claim settlement process involve human reviewers which are expensive and error prone.

Accordingly, to greatly increase the speed and reliability of claim settlement, the environment 100 includes a real-time claim processing system 110 that in real-time, or near real-time, settles received claims 107 from submitters 101 for third-party payors 150 using one or more smart contracts 111. As used herein a smart contract 111 includes computer code that defines a set of rules that relate to validating a claim 107, paying a claim 107, and settling a claim 107.

The smart contract 111 may be stored on a distributed ledger associated with the real-time claim processing system 110 and may be managed by the operator of the distributed ledger or another party with the appropriate permissions to write smart contracts 111. The distributed ledger 125 may be implemented as a distributed network of computing nodes (e.g., a P2P network) that stores values or records on a blockchain. Once written to the distributed ledger 125, the rules of the smart contract 111 cannot be changed or revised without creating a new smart contract 111. Alternatively or additionally, the smart contract 111 may be stored outside of the distributed ledger 125. Note that smart contracts 111 stored outside the distributed leger 125, for example in middleware, may be updated and private. Submitters would not have access to these smart contracts unless they have access to the environment in which they are stored. Smart contracts stored outside of the distributed ledger 125 may be “logic” or “rules” that instruct interactions with the ledger 125.

The third-party payors 150 may formalize their insurance policies, reimbursement rates, and/or claims processing rules with clients and submitters 101 as smart contracts 111 and the real-time claim processing system 110 may write the smart contracts 111 to the distributed ledger 125 (or another location). In response, the distributed ledger 125 may return one or more transaction identifiers 126 that may be used to identify the execution of the smart contract 111 on the distributed ledger 125. Where the smart contract 11 is not stored on the ledger 125, the transaction identifier 126 may be a pointer or reference to the location where the smart contract 111 is stored or made available. Each transaction written to the distributed ledger 125 may have its own associated transaction identifier 126.

The real-time processing system 110 may receive a claim 107 from a submitter 101. The claim 107 may be associated with a claim identifier 108 that uniquely identifies the claim 107. Depending on the embodiment, the claim 107 may be received with the claim identifier 108, or the claim identifier 108 may be assigned to the received claim 107 by the real-time claim processing system 110.

The claim 107 may be a claim for reimbursement for medical services provided to an individual by a submitter 101. The submitter 101 may be the medical service provider who rendered the medical service to an individual, an entity submitting the claim 107 on behalf of the service renderer, or the individual who received the medical service. The claim 107 may include an identifier of the individual that received the medical service, an identifier of the medical provider, a payment 151 that is requested for the claim 107, an identifier of the medical service, and an identifier of the third-party payor 150 that is asked to pay the claim 107. Other information that may support the claim 107 such as demographic information and medical history information associated with the individual associated with the claim 107 may be included. Depending on the embodiment, some of the data associated with the claim 107 may be stored in a record or database associated with the submitter 101. The claim 107 may include an address or reference to the record or database that may be used to access the data. Depending on the embodiment, the data may or may not be stored on the distributed ledger 125.

In response to receiving the claim 107, the real-time processing system 110 may write the claim to the distributed ledger 125. Writing the claim 107 to the distributed ledger 125 may include writing a transaction identifier 126 to the the ledger 125 along with metadata about the claim 107. The metadata may include the claim identifier 108, a status of the claim 107, and a hash of the claim 107 or and/or a reference to any stored data associated with the claim 107. Other metadata such as timestamp and a cryptographic signature of the device that created or originated the claim 107 may also be included. Because the claim 107 was just received, the status of the claim 107 may be initially set to received or created.

The real-time claim processing system 110 may determine the smart contract 111 (or smart contracts 111) that is associated with the received claim 107. The smart contract 111 may be associated with the individual that submitted the claim 107 and the third-party payor 150. Depending on the embodiment, the applicable smart smart contract 111 (or smart contracts 111) may be specified or referenced in a policy or agreement between the third-party payor 150 and the individual that submitted the claim 107. The real-time claim processing system 110 may also determine the transaction identifier 126 that identifies the associated smart contract 111 on the distributed ledger 125.

The real-time claim processing system 110 may cause the received claim 107 to be executed and validated by the smart contract 111 on the distributed ledger 125. As part of the execution, in some embodiments, the smart contract 111, or the system 110, may invoke or call one or more bots 112. As used herein a bot 112 may be a specialized computer program that is configured to retrieve or validate certain types of information. For example, a bot 112 may be configured to retrieve additional information or medical history information about the individual that is necessary to validate the claim 107.

If the claim 107 is validated, the real-time processing system 110 (or the smart contract 111) may change the state of the claim 107 to validated and may write the validated claim 121 to the distributed ledger 125. Writing the validated claim 121 to the distributed ledger 125 may include writing a transaction identifier 126 of the validated claim 121 to the ledger 125 along with metadata about the validated claim 121. The metadata may include the claim identifier 108 of the original claim 107, the status of the validated claim 121 as validated, and an indicator of the smart contract 111 that validated the claim 107. In some embodiments, the indicator of the smart contract 111 may include a digital signature of the smart contract 111 that validated the claim 107 and/or digital signatures of any other computing devices or bots 112 that were involved in validating the claim 107. Other metadata such as a timestamp and any previous transaction identifiers 126 associated with the validated claim 121 and/or the received claim 107 may be included.

After the claim 107 has been validated as the validated claim 121, the real-time processing system 110 may proceed with pricing the validated claim 121. Pricing the validated claim 121 may include determining payments 151 that should be made from the third-party payor 150 associated with the validated claim 121 to the submitter 101 or individual associated with the validated claim 107. In some embodiments, the pricing may be performed by a proprietary algorithm or proprietary pricing model that is associated with the third-party payor 150. Pricing the validated claim 121 may also involve determining any payment 151 that is the responsibility of the individual associated with the validated claim 121. As defined herein payment 151 may include an amount of money requested or transferred between parties.

In some embodiments, the validated claim 121 may be priced using a same or different smart contract 111 that was used to validate the received claim 107. The smart contract 111 may price the validated claims 121 using one or more bots 112 that are configured to price validated claims 121. Alternatively, the real-time claim processing system 110 may price the validated claim 121 without using a smart contract 111.

After the validated claim 121 has been priced as the priced claim 131, the real-time processing system 110 (or the smart contract 111) may change the state of the validated claim 121 to priced and may write the priced claim 131 to the distributed ledger 125. Writing the priced claims 131 to the distributed ledger 125 may include writing a transaction identifier 126 of the priced claim 131 to the the ledger 125 along with metadata about the priced claim 131. The metadata may include the claim identifier 108 of the original claim 107, the status of the priced claim 131 as priced, and an indicator of the smart contract 111 that priced the validated claim 121. In some embodiments, the indicator of the smart contract 111 may include a digital signature of the smart contract 111 that priced the validated claim 121 and/or digital signatures of any other computing devices or bots 112 that were involved in pricing the validated claims 121. Other metadata such as a timestamp and any previous transaction identifiers 126 of the claim 107 may be included.

After the validated claim 121 has been priced as the priced claim 131, the real-time processing system 110 may continue to settle the priced claim 131. Settling the priced claim 131 may include establishing commitments of various parties to pay the amounts determined for the priced claim 131.

In some embodiments, the priced claim 131 may be settled using a same or different smart contract 111 that was used to validate the received claim 107 or price the validated claim 121. In particular, the smart contract 111 may settle the claim using one or more bots 112.

After the priced claim 131 has been settled as the settled claim 141, the real-time processing system 110 (or the smart contract 111) may change the state of the priced claim 131 to settled and may write the settled claim 141 to the distributed ledger 125. Writing the settled claim 141 to the distributed ledger 125 may include writing a transaction identifier 126 of the settled claim 141 to the the ledger 125 along with metadata about the settled claim 141. The metadata may include the claim identifier 108 of the original claim 107, the status of the settled claim 141 as settled, and an indicator of the smart contract 111 that settled the priced claim 131. In some embodiments, the indicator of the smart contract 111 may include a digital signature of the smart contract 111 that settled the priced claim 131 and/or digital signatures of any other computing devices or bots 112 that were involved in settling the priced claim 131. Other metadata such as a timestamp and any previous transaction identifiers 126 of the claim may be included.

After settling the received claim 107, the real-time processing system 110 may provide the settled claim 141 to the submitter 101 along with the one or more transaction identifiers 126 associated with the settled claim 141. The submitter 101 (or other permissioned entity or party) may then later use the one or more transaction identifier 126 to retrieve the settled claim 141 from the distributed ledger 125 as proof that the claim 107 was in fact settled. Depending on the embodiment, the metadata associated with the settled claim 141 on the ledger 125 may include the one or more transaction identifiers 126 of the corresponding priced claim 131, validated claims 121, and received claim 107 that be used as further proof that the claim was received, validated, and priced.

In some embodiments, the real-time processing system 110 may further facilitate one or more payment(s) 151 for the settled claim 141. In such embodiments, the real-time processing system 110 may initiate the transfer of funds between one or more financial accounts associated with the third-party payor 150 and one or more more financial accounts associated with the submitter 101 and/or the individual that submitted the original claim 107. For example, the real-time claim processing system 110 may initiate an ACH transfer between a financial account associated with the third-party payer 150 and an account associated with the submitter 101. Alternatively, the real-time processing system 110 may facilitate the transfer of payment(s) 151 from an intermediary payor to the submitter 101. The third-party payor(s) 150 may then later reimburse the intermediate payor for the payment(s) 150.

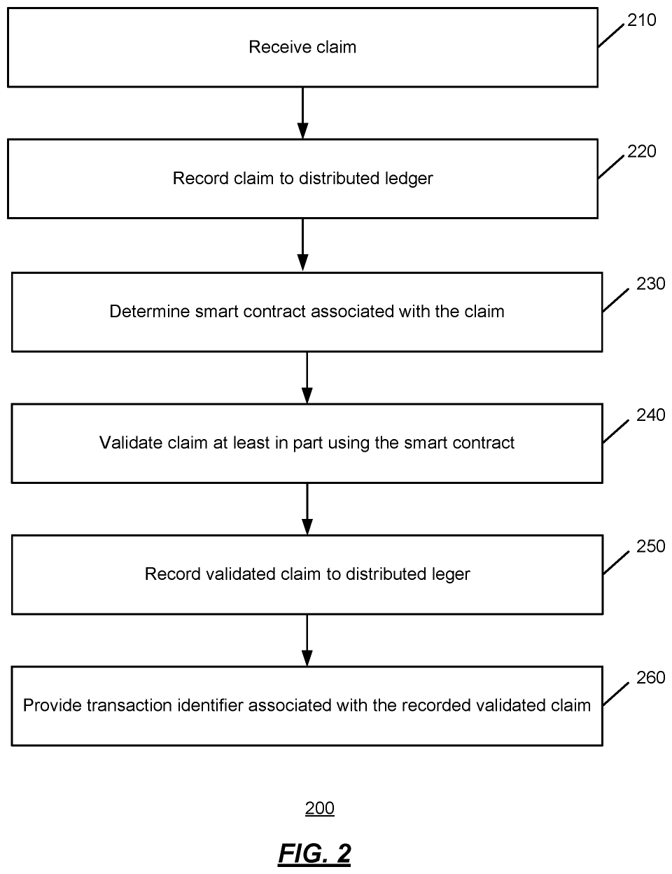

FIG. 2 is an illustration of a method 200 for validating a claim. The method 200 may be implemented by the real-time claim processing system 110.

At 210, a claim is received. The claim 107 may be received by the real-time claim processing system 110 from a submitter 101. The claim 107 may be a medical claim and may be a request for reimbursement for a medical service provided by the medical provider. The claim 107 may be associated with a claim identifier 108. In some embodiments, the claim 107 may include information such as documents that may be used to validate the claim 107 or may include a link to one or more locations where such information can be retrieved. The claim 107 may be associated with an individual that received the medical service and one or more third-party payor 150 that are requested to pay the claim 107.

At 220, the claim is recorded to a distributed ledger. The claim 107 may be recorded by the real-time claim processing system 110. The distributed ledger 125 may be a distributed network of nodes that may write or record data to a blockchain. Depending on the embodiment, recording the claim 107 to the distributed ledger 125 may include writing the claim 107, or some portion of the claim 107, to the distributed ledger 107 including the claim identifier 108 and some or all of the supporting information associated with the claim 107. Writing the claim 107 to the distributed ledger 125 may include writing a transaction identifier 126 that uniquely identifies the location of the claim 107 written to the distributed ledger 125 or written to an off-chain database.

At 230, a smart contract 111 associated with the received claim is determined. Depending on the embodiment, the smart contract 111 may be stored on the distributed ledger 125 and may be determined using a transaction identifier 126 associated with the smart contract 111. For example, the transaction identifier 126 may be referenced in a policy or other agreement between the individual associated with the claim 107 and one or more third-party payors 150. The smart contract 111 may be a computer program that encodes one or more rules associated with a medical insurance policy or contract between an individual and one or more third-party payors 150 associated with the claim 107. Alternatively or additionally, the smart contract 111 may be a computer program that encodes one or more rules that orchestrate claim 107 validation.

At 240, the claim is validated at least in part by the smart contract. The claim may be validated by the real-time claim processing system 110 using the smart contract 111. Depending on the embodiment, the smart contract 111 may be executed on the received claim 107 by the real-time processing system 110 or by the distributed ledger 125. As part of the execution, the smart contract 111 may invoke or call one or more bots 112 to assist in validating the claim 107. Furthermore, a bot 112 may invoked or call on one or more other smart contracts 111 or other bots 112 to perform further validation.

At 250, the validated claim is recorded to the distributed ledger. The validated claim 121 may be recorded by the real-time claim processing system 110. The real-time processing system 110 may record the validated claim by writing to the distributed ledger 125 one or more of: a transaction identifier 126; signatures of the smart contracts 111, bots 112, and/or computing devices involved in the validation of the claim 107; a status of validated, the claim identifier 108; and a timestamp. Other information may be written to the distributed ledger 125.

At 260, a transaction identifier associated with the recorded validated claim is provided. The transaction identifier 126 may be provided by the real-time claim processing system 110. The transaction identifier 126 may be provided to the submitter 101 (and other counter parties) as proof that the claim 107 was validated.

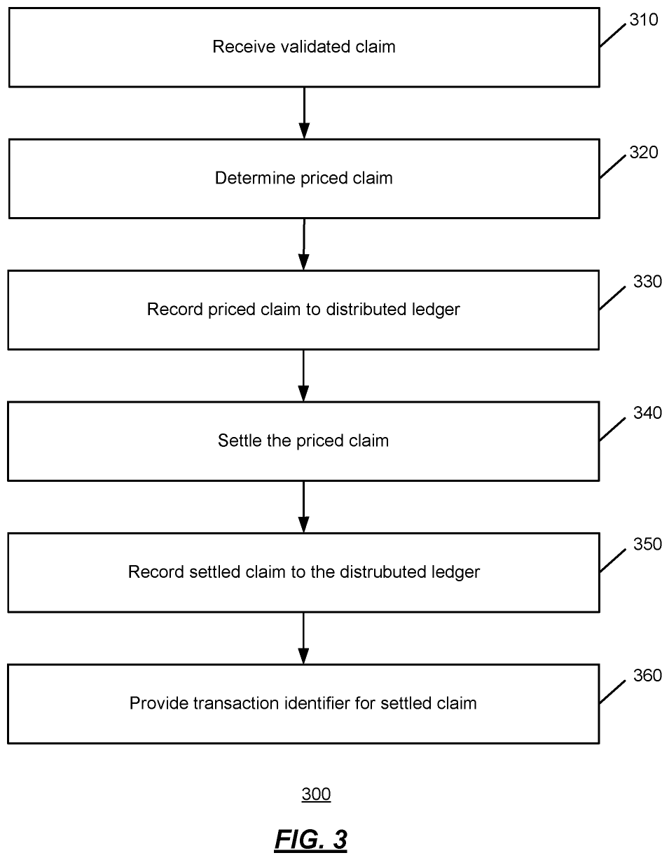

FIG. 3 is an illustration of a method 300 for settling a claim. The method 300 may be implemented by real-time claim processing system 110.

At 310, a validated claim is received. The validated claim 121 may be received by the real-time claim processing system 110. The validated claim 121 may correspond to the received claim 107 that was validated by the method 200.

At 320, a priced claim is determined. The priced claim 131 may be determined by the real-time claim processing system 110 pricing the validated claim 121. The priced claim 131 may be determined using the same or different smart contract 111 than that was used to validate the claim 107 in the method 200. The priced claim 131 may indicate a payment 151 to make for the validated claim 121 from one or more third-party payors 150 to the submitter 101 and/or an individual that received the medical services associated with the validated claim 121.

At 330, the priced claim is recorded to a distributed ledger. The priced claim 131 may be recorded by the real-time claim processing system 110. The real-time processing system 110 may record the validated claim 121 by writing to the distributed ledger 125 one or more of: a transaction identifier 126; signatures of the smart contracts 111, bots 112, and/or computing devices involved in the pricing of the validated claim 121; a status of priced, the claim identifier 108; and a timestamp. Other information may be written to the distributed ledger 125.

At 340, the priced claim is settled. The priced claim 131 may be settled to create the settled claim 141 by the real-time claim processing system 110 using the same or different smart contract 111 than that was used to validate and/or price the claim 107. Settlement may include establishing commitments of various parties to pay the amounts determined for the priced claim 131. Depending on the embodiment, after the claim has been settled, the settled claim 141 may be paid by causing one or more payment 151 to be transferred from an account associated with the third-party payor (or payors) 150 to an account associated with the submitter 101 and/or the individual associated with the claim 107. Any method for processing or facilitating payments 151 between parties may be used.

At 350, the settled claim is recorded to the distributed ledger. The settled claim 141 may be recorded by the real-time claim processing system 110. The real-time processing system 110 may record the settled claim 141 by writing to the distributed ledger 125 one or more of: a transaction identifier 126; signatures of the smart contracts 111, bots 112, and/or computing devices involved in the settling of the priced claim 131; a status of settled, the claim identifier 108; and a timestamp. Other information may be written to the distributed ledger 125.

At 360, a transaction identifier of the settled claim is provided. The transaction identifier 126 of the settled claim 141 may be provided by the the real-time claim processing system 110 to the submitter 101 that provided the claim 107, or other permitted parties. The submitter 101 may then use the transaction identifier 126 to retrieve and verify the settled claim 141 from the distributed ledger 125.

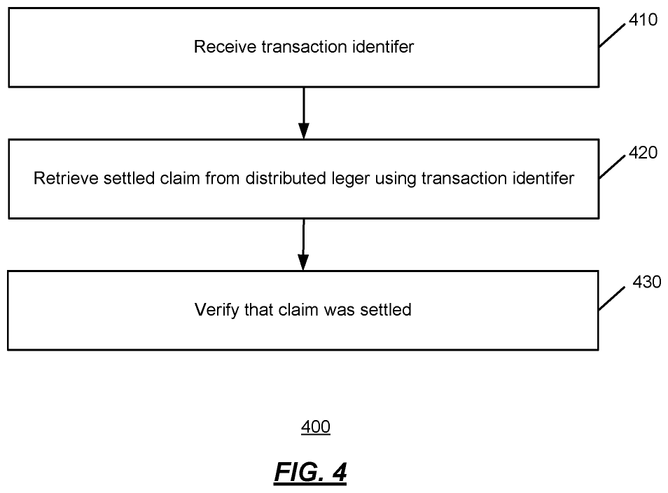

FIG. 4 is an illustration of a method 400 for verifying that a claim was settled. The method 400 may be implemented by the real-time claim processing system 110.

At 410, a transaction identifier is received. The transaction identifier 126 is received by the real-time claim processing system 110 from a submitter 101. The transaction identifier 126 identifies a record written to the distributed ledger 125. The submitter 101 would like to verify that a claim 107 corresponding to the transaction identifier 126 was settled as indicated. Alternatively, a third-party payor 150, or other interested party, may desire to verify that the claim 107 was settled.

At 420, the settled claim is retrieved from the distributed ledger using the transaction identifier. The settled claim 141 may be retrieved from the distributed ledger 125 by the real-time processing system 110.

At 430, that the claim was settled is verified. The real-time claim processing system 110 may provide the settled claim 141 to the submitter 101 and/or the third-party payor 150 that provided the transaction identifier 126 as verification.

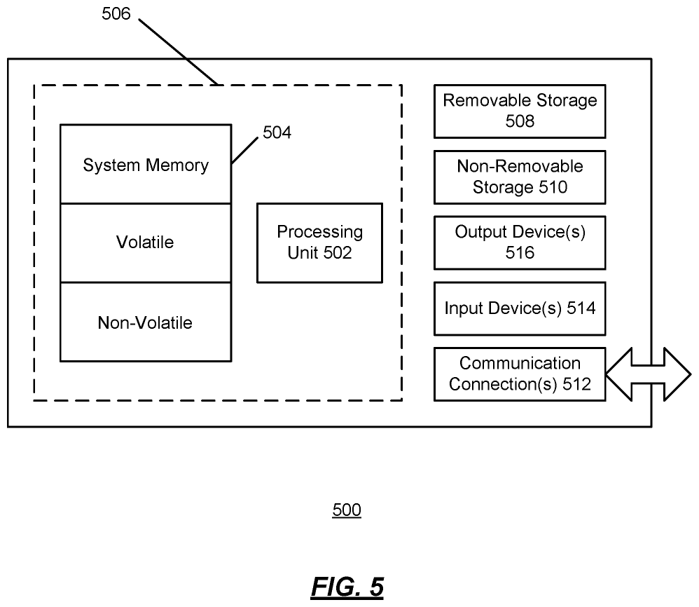

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by the device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a claim by a computing device, wherein the claim is associated with a claim identifier;
recording the received claim to a distributed ledger by the computing device;
determining a smart contract associated with the claim by the computing device;
validating the received claim using the determined smart contract by the computing device;
recording the validated received claim to the distributed ledger by the computing device; and
providing a first transaction identifier associated with the recorded validated received claim on the distributed ledger by the computing device.

2. The method of claim 1, wherein validating the received claim using the determined smart contract by the computing device comprises invoking one or more bots identified by the smart contract and validating the received claim using the one or more bots.

3. The method of claim 1, wherein the smart contract comprises a computer program.

4. The method of claim 1, wherein recording the validated claim to the distributed ledger comprises recording the first transaction identifier associated with the validated claim, the claim identifier, a signature associated with the smart contract, and a time when the claim was validated to the distributed ledger.

5. The method of claim 1, wherein the distributed ledger is a blockchain distributed ledger.

6. The method of claim 1, further comprising:
determining a price for the validated claim using the smart contract;
recording the priced claim to the distributed ledger; and
providing a second transaction identifier associated with the recorded priced claim on the distributed ledger.

7. The method of claim 6, wherein recording the priced claim to the distributed ledger comprises recording the second transaction identifier, the claim identifier, a signature associated with the smart contract, the first transaction identifier, and a time when the claim was priced to the distributed ledger.

8. The method of claim 6, further comprising:
settling the priced claim using the smart contract;
recording the settled claim to the distributed ledger; and
providing a third transaction identifier associated with the recorded settled claim on the distributed ledger.

9. The method of claim 8, wherein recording the settled claim to the distributed ledger comprises recording the third transaction identifier, the claim identifier, a signature associated with the smart contract, the first transaction identifier, the second transaction identifier, and a time when the claim was settled to the distributed ledger.

10. A system for processing claims comprising:
a distributed ledger; and
at least one computing device that executes one or more stored instructions that cause the at least one computing device to:
receive a claim, wherein the claim is associated with a claim identifier;
record the received claim to a distributed ledger by the computing device;
determine a smart contract associated with the claim;
validate the received claim using the determined smart contract;
record the validated received claim to the distributed ledger; and
provide a first transaction identifier associated with the recorded validated received claim on the distributed ledger.

11. The system of claim 10, wherein validating the received claim using the determined smart contract by the computing device comprises invoking one or more bots identified by the smart contract and validating the received claim using the one or more bots.

12. The system of claim 10, wherein the smart contract comprises a computer program.

13. The system of claim 10, wherein recording the validated claim to the distributed ledger comprises recording the first transaction identifier associated with the validated claim, the claim identifier, a signature associated with the smart contract, and a time when the claim was validated to the distributed ledger.

14. The system of claim 10, wherein the distributed ledger is a blockchain distributed ledger.

15. The system of claim 10, further comprising:
determining a price for the validated claim using the smart contract;
recording the priced claim to the distributed ledger; and
providing a second transaction identifier associated with the recorded priced claim on the distributed ledger.

16. The system of claim 15, wherein recording the priced claim to the distributed ledger comprises recording the second transaction identifier, the claim identifier, a signature associated with the smart contract, the first transaction identifier, and a time when the claim was priced to the distributed ledger.

17. The system of claim 15, further comprising:
settling the priced claim using the smart contract;
recording the settled claim to the distributed ledger; and
providing a third transaction identifier associated with the recorded settled claim on the distributed ledger.

18. The system of claim 17, wherein recording the settled claim to the distributed ledger comprises recording the third transaction identifier, the claim identifier, a signature associated with the smart contract, the first transaction identifier, the second transaction identifier, and a time when the claim was settled to the distributed ledger.

19. A non-transitory computer-readable medium storing instructions that when executed by a computing device cause the computing device to:
receive a claim, wherein the claim is associated with a claim identifier;
record the received claim to a distributed ledger by the computing device;
determine a smart contract associated with the claim;
validate the received claim using the determined smart contract;
record the validated received claim to the distributed ledger; and
provide a first transaction identifier associated with the recorded validated received claim on the distributed ledger.

20. The computer-readable medium of claim 19, wherein validating the received claim using the determined smart contract by the computing device comprises invoking one or more bots identified by the smart contract and validating the received claim using the one or more bots.

21. A method for the real-time settlement of a claim using a smart contract and distributed ledger, the method comprising:
receiving a claim by a computing device, wherein the claim is associated with a claim identifier;
determining a smart contract associated with the claim by the computing device;
settling the received claim using the determined smart contract by the computing device;
recording the settled claim to a distributed ledger by the computing device; and
providing a transaction identifier associated with the recorded settled claim on the distributed ledger by the computing device, wherein the transaction identifier comprises proof that the claim was settled.
